(19) United States
(12) Patent Application Publication
(10) Pub. No.: US 2007/0208640 A1
(43) Pub. Date: Sep. 6, 2007

(54) Method and Apparatus for Assessing Debtor Payment Behavior

(76) Inventors: Michael J. Banasiak, Brielle, NJ (US); Theodore R. Shalack, New Brunswick, NJ (US)

Correspondence Address: PATTERSON & SHERIDAN L.L.P., 595 SHREWSBURY AVE, STE 100, FIRST FLOOR, SHREWSBURY, NJ, 07702, US

(21) Appl. No.: 11/677,560

(22) Filed: Feb. 21, 2007

Related U.S. Application Data
(60) Provisional application No. 60/775,299, filed on Feb. 21, 2006.

(51) Int. Cl. G06Q 40/00

(52) U.S. Cl. 705/35

(57) ABSTRACT

A computer implemented method that merges historical debtor placement data and historical credit data according to a bivariate analysis to create model of debtor behavior. The model is adapted for processing current debtor placement data and credit data to value a debt portfolio or determine a probability of payment and/or estimate of payment of individual debtors.

### CROSS REFERENCE TO RELATED APPLICATIONS

This application claims the benefit of U.S. Provisional Patent Application Ser. No. 60/775,299 filed Feb. 21, 2006 which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to forecasting systems that model payment behavior of debtors such as credit card account holders with outstanding balances or patients with unpaid medical bills. More particularly, the invention relates to a computer implemented method and apparatus for modeling the debtor/patient behavior to value associated collections activity.

### BACKGROUND OF THE INVENTION

For some time companies have been using statistical-based modeling to assess the risk of payment inherent in doing business with potential and present customers. Typical of these methodologies is the use of credit information gleaned from one or more of the major credit bureaus to assess whether an individual or business entity with whom the company is contemplating doing business has a record of appropriate payment. Thus, based on statistical relationships found in past history, an assessment of a future likelihood of appropriate payment or non-payment may be made. This past history may also include responses to collections efforts and the like. Unfortunately, the present methodologies do not adequately determine whether a debtor is likely to repay and, in the event of such repayment, the amount or percentage of outstanding debt likely to be recovered.

### SUMMARY OF THE INVENTION

Various deficiencies in the prior art are addressed through the invention of a computer implemented methodology and apparatus for modeling debtor payment behavior after one or more credit events and/or patient payment behavior after one or more medical procedures to determine a value of collections activity, such as queuing, prioritizing of activities to enhance collections, minimizing the cost of collections and the like.

Generally speaking, the invention helps determine a likelihood of repayment and/or an amount of repayment likely to be received for a debtor or patient such that an appropriate collections strategy and collections effort level may be determined. Although the invention is generally applicable to creditors, collection agencies, or debt buyers, it can also be customized for a particular creditor, collection agency or debt buyer.

The invention merges historical placement data and historical credit data according to a bivariate analysis to create an algorithm or process that models or characterizes debtor behavior. The algorithm is stored in memory and subsequently used to process current placement and credit data to assess individual debtor behavior to evaluate thereby a likelihood of payment and/or an amount of payment. Optionally, the correlation of debtor behavior to the model is improved by adapting or generating specific models according to debt type and/or debtor type (e.g., vehicle loans, medical bill, mortgages etc.).

Various embodiments of the invention provide a method for modeling debtor behavior, comprising: obtaining historic customer placement data for each of at least one debtor in a debt portfolio; obtaining historic credit data for each of the at least one debtor in the debt portfolio; determining a probability of payment model by processing the historic customer placement data and historic credit data according to either of (1) a generalized linear modeling technique with a link function based upon a Generalized Beta of the Second Kind (GB2) family of distributions or (2) a generalized linear modeling technique using a link function based upon a member of the G-and-H family of distributions; and storing, in a memory, values corresponding to the probability of payment model.

One embodiment includes determining an expected conditional sum of payments model by processing the historic customer placement data and historic credit data according to either of (1) a generalized linear modeling technique using a member of the natural exponential family or (2) a maximum likelihood estimation fit to a member of the GB2; and storing, in the memory, values corresponding to the expected conditional sum of payments model.

Another embodiment includes determining an expected monetary amount using the probability of payment and the expected conditional sum.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a computer implemented apparatus according to an embodiment of the invention;

FIG. 2 depicts a flow diagram of methods for developing a blended recovery strategy for a debt portfolio; and

FIG. 3 depicts a flow diagram of a method for implementing a blended recovery strategy;

FIG. 4 depicts a high-level block diagram of a general-purpose computer suitable for use in performing the functions described herein;

FIG. 5 depicts a sample incidence predictions report; and

FIG. 6 depicts a sample dollar predictions report.

To facilitate understanding, identical reference numerals have been used, where possible, to designate identical elements that are common to the figures.

### DETAILED DESCRIPTION OF THE PREFERRED EMBODIMENTS

The invention will be described within the context of a methodology for modeling debtor payment behavior after one or more credit events according to a likelihood of repayment and/or an amount of repayment likely to be received. While the descriptions herein may focus on debtor behavior, it is to be understood that the term debtor is also intended to include the term patient since a patient may have accumulated significant medical debt and may exhibit payment behavior similar to that of other debtors.

The invention will be described within the context of several applications in which a debtor behavior modeling finds particular utility, including a debt buying application, a collection agency application and a creditor application. Other applications will be readily apparent to one skilled in the art and informed by the teachings of the present invention.

The invention finds particular utility with creditors, collection agencies, and debt buyers. Creditors may beneficially use the invention to make decisions regarding the ranking of debtors for internal recovery purposes, as well as determining which debtor accounts to retain, which to outsource and which to sell. Collection agencies may beneficially use the invention to identify those accounts not likely to pay versus those accounts likely to pay and to value weight the probability of such payment associated with each debtor account. Debt buyers may beneficially use the invention to evaluate debt portfolio purchases and segments thereof. That is, from a debt buyer perspective, it is important to understand the value of a portfolio that might be purchased; from a collection agency perspective, it is important to determine the most collectable (i.e., most profitable) accounts to which collection activities should then be applied; and from a creditor perspective it is important to prioritize its own accounts for internal collections, to determine which debtor accounts to outsource to external collection agencies, and to determine which debtor accounts it would like to sell. The subject invention addresses all of these perspectives.

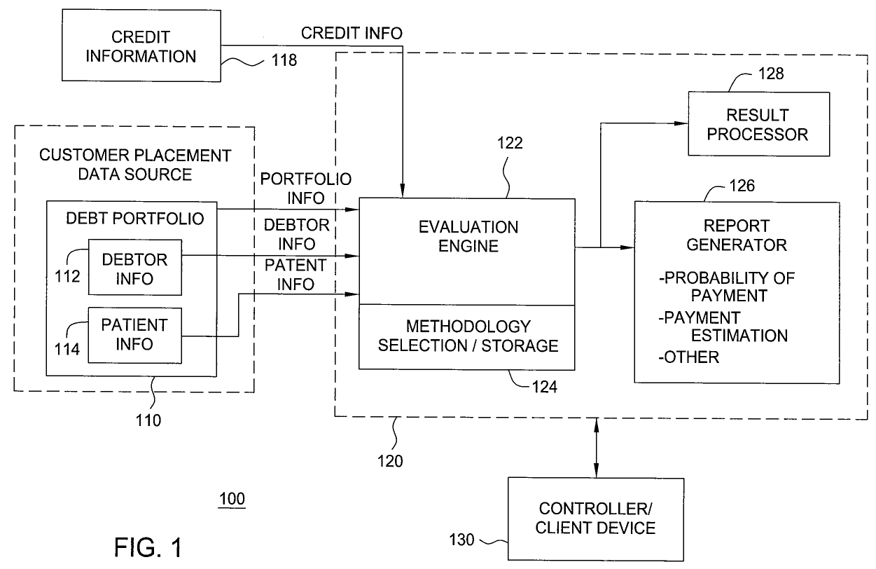

FIG. 1 depicts a high-level block diagram of functional elements associated with an embodiment of the invention. Specifically, FIG. 1 depicts a Customer Placement Data Source, illustratively a debt portfolio 110 including debtor information 112 and/or patient information 114 that provides at least one of portfolio information, debtor information and patient information to an evaluation system 120. This information comprises a first data set for processing by the evaluation system 120. Additionally, a Credit Information Data Source 118 provides a second data set for processing by the evaluation system 120. The Credit Information Data Source 118 comprises, illustratively, a commercial or private source of credit information pertaining to each debtor or patient in the Customer Placement Data Source 110. Other databases (not shown) such as demographic databases may be used to provide information to the evaluation system 120, as discussed below.

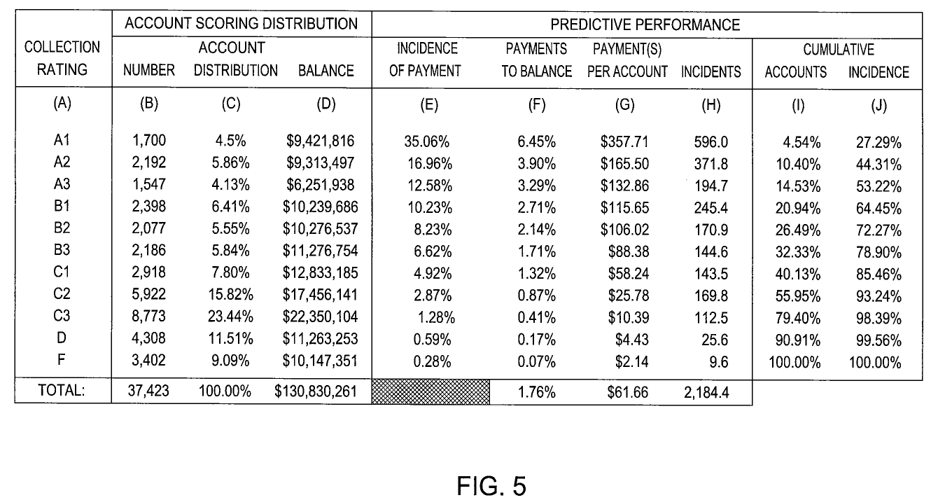

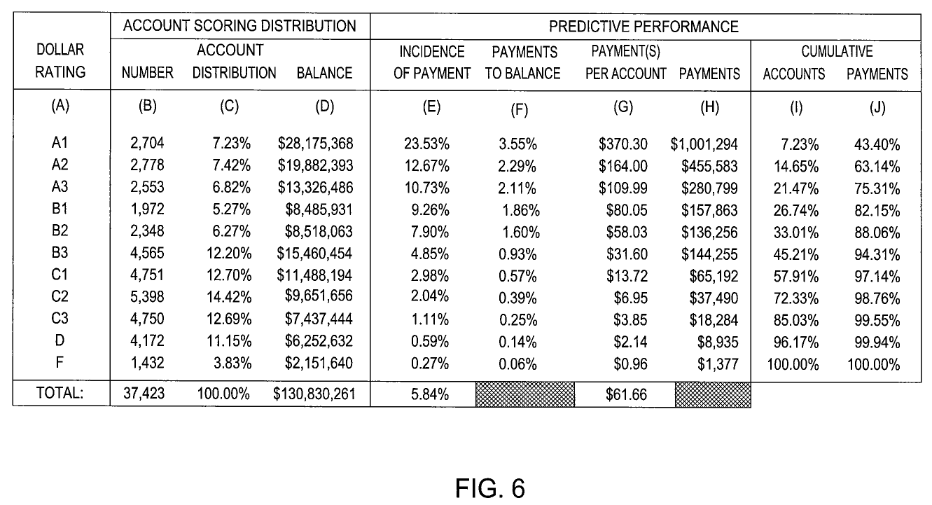

The evaluation system 120 comprises an evaluation engine 122 which processes the two received data sets according to, illustratively, any of a plurality of algorithms provided by a methodology selection/storage unit 124. The output of the evaluation engine 122 is provided to a report generator 126 for providing a machine readable or human readable report. Several exemplary reports will be discussed below with respect to FIGS. 5-6. Optionally, a result processor 128 performs further processing of the evaluation engine output to derive additional information, such as comparisons of a present portfolio, debtor or patient to a previously processed portfolio, debtor or patient.

The evaluation system 120 is depicted in FIG. 1 as being controlled by a controller/client device 130, illustratively a general purpose computer. The controller 130 operates to, illustratively, cause specific algorithms to be selected by the evaluation engine, cause specific reports to be generated by the report generator 126, cause specific post-processing operations to be performed by the result processor 128 and so on. The controller 130 operates to receive information from any of the functional elements depicted in FIG. 1.

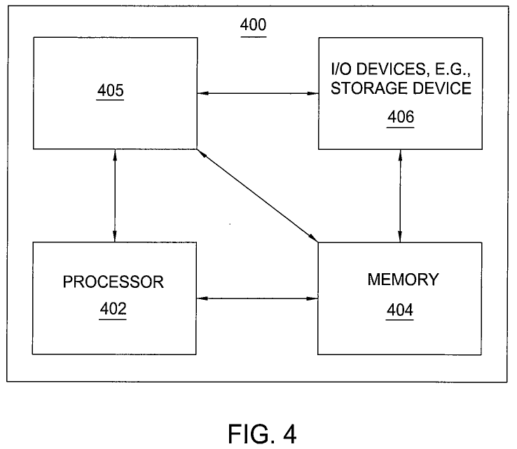

Each of the functional elements depicted in FIG. 1 may be implemented as one or more computing devices such as, for example, described in more detail below with respect to FIG. 4. Generally speaking, the functional elements of FIG. 1 may be combined in any way within the context of one or more general purpose or special computing devices to implements the various functions associated with the present invention, as described herein.

While generally described as processing customer placement data in combination with credit history data, various embodiments of the invention are implemented by processing one of both of customer placement data and credit history data. Moreover, demographic data and other data may also be processed in combination with either or both of the customer placement data and credit history data.

The evaluation engine 122 is adapted to evaluate a portfolio of debt or an individual debtor or patient. The debt portfolio typically comprises accounts receivable (A/R) that have been deemed by one or more creditors to be uncollectible or not worth collecting because the accounts have reached a status of severe delinquency status or write-off. Debt portfolios comprised of slightly delinquent accounts or even fresh unpaid medical bills can be evaluated as well. Debt portfolios may be produced by, for example, a company or group of companies that would like to get some return on their uncollected A/R but may not have the in-house collections expertise to generate a sufficient return. Alternatively, a company may use portfolio sales to manage their balance sheet. The portfolio is offered for sale to a debt buyer, typically at a discount to the face value of the uncollected A/R. The debt buyer should estimate the value of the portfolio. More specifically, the debt buyer should estimate how much of the uncollected A/R may be ultimately collected and the likely cost to the debt buyer of realizing those collections.

A collection agency may use the invention to perform various tasks, including (1) scoring new placements for collections from creditors and other third parties (e.g. debt buyers and other collection agencies); and (2) scoring its existing inventory of accounts to re-estimate the probabilities of payments and expected value of such payments.

(1) Scoring new placements for collections from creditors and other third parties (e.g. debt buyers and other collection agencies). Typically a creditor has debts to be collected on a contingency basis by a collection agency. These placements can occur at any time, monthly, weekly, daily or more often. The collection agency receives the placement data from the creditor. If credit bureau data is not sent along with the placement data, either the agency or the algorithm holder obtains the credit bureau data to run the algorithm implementation process. The collection agency then uses the scores to, for example, prioritize a collection queue from highest collectable based upon the probability of payment and/or the amount of payment. Such projections may be adapted for minimizing costs of collections on less collectable debt, forecasting profitability and allocating human resources, mail and telephone programs, legal suits and other collection tactics.

(2) Scoring its existing inventory of accounts to re-estimate the probabilities of payments and expected value of such payments. As the collection agency gathers placements over time, scores need to be updated periodically in order to align the payment prediction with the current placements. Activity (or non activity) since placement or date of prior score may affect the rescore as well as any changes to the debtor information or updates to credit bureau data. The same uses above would apply.

A creditor may use the invention to perform various tasks, including: (1) prioritizing collection activities and conducting similar/related duties as an internal collection agency; (2) using the predicted probabilities and payment amounts to determine which debtor accounts should be sold to another party (i.e., keep the predicted probabilities and payment amounts to manage and allocate accounts to its collection agencies and attorneys (e.g. for collection legal action).

The evaluation engine receives as input two databases or data sets. The first input data set is also known as Customer Placement Data (see, e.g., Table 1 as an example) and comprises information pertaining to the debt portfolio itself. This information includes, for each receivable or credit event, at least the amount and age of the receivable, as well as the identities of the respective debtor (this is only necessary to obtain credit bureau data) and, optionally, the creditor. Optional information includes the type of service or goods and other information pertaining to the debtor's account and collections events packaged within the debtor portfolio. This information is typically provided by the entity trying to sell the portfolio. The second input data set comprises credit information pertaining to each debtor in the portfolio. This credit history information may be provided by the entity selling the debt portfolio, by a consumer or commercial credit bureau, by a group of similarly situated companies and the like.

The evaluation engine processes the two input databases or data sets according to one or more algorithms to provide several output scores and/or data sets. A first output score comprises a hierarchical listing of which debtors are likely to pay (i.e., a ranking of debtors according to the evaluated likelihood of payment). A high rank on this list indicates a relatively higher likelihood of repayment. A second output score comprises a hierarchical listing of how much the debtors are likely to pay (i.e., a ranking of debtors according to the evaluated amount of payment, weighted by the evaluated likelihood of repayment, the expected monetary amount). A high rank on this list indicates a relatively higher amount of repayment.

A first algorithm (“Algorithm 1”) associated with an embodiment of the evaluation engine utilizes a generalized linear modeling technique with a link function that is an inverse Cumulative Density Function from the Generalized Beta of the Second Kind family of distributions to provide a maximum likelihood estimation of the probability of payment for each account in the debtor population and generates thereby the first output data set. This four parameter distributional family includes logistic regression as a specialized form of this technique. Logistic regression usually works well, where working well refers to the maximum likelihood statistic of the model penalized for complexity with a criterion such as the Schwartz Bayes Criterion. The algorithm also examines link functions that are an inverse Cumulative Density Function from the G-and-H family of distributions. The G-and-H family (also a 4 parameter distributional family) includes probit regression as a specialized form of the technique. Probit regression usually works well (as defined above) within the G-and-H family, however, logistic regression is usually superior to probit regression in terms of the maximum likelihood statistic of the model. For this algorithm the dependent variable is dichotomous with 0 indicating non payment and 1 indicating payment. This algorithm uses credit history information from the second input data set for each debtor and applies the extracted information to the credit events of the respective debtors included within the first data set. Thus credit and/or placement data determines a probability of payment that is used to determine the relative credit worthiness of the debtors. The probability of payment is used to rank the debtor population within the debtor portfolio and provide thereby the first output score. Alternatively, one or more of a neural network processing technique, a linear regression technique, a discriminant analysis technique and a random forests technique as well as other techniques) may be used to generate the first output data set.

A second algorithm (“Algorithm 2”) associated with an embodiment of the evaluation engine utilizes a general linear model to provide a maximum likelihood estimation of the sum of the amount of payments conditional that payments have been made. Alternatively a generalized linear modeling technique using a member of the natural exponential family such as Normal, Poisson, Gamma, Inverse Gaussian, Negative Binomial, Logarithmic, and Compound Poisson/Gamma and/or other distributions is used. The Gamma distribution usually works well (as defined above) within the natural exponential family; however, the general linear model regression is usually superior to this distribution in terms of the maximum likelihood statistic of the model. The model also fits distributions from the Generalized Beta of the Second Kind family of distributions using Maximum Likelihood Estimation. The Generalized Beta of the Second Kind family (a 4 parameter distributional family) includes Burr III, Weibull, Lognormal and Standard Beta distributions as specialized forms. The Standard Beta tends to work well (as defined above) within the Generalized Beta of the Second Kind family; however, the general linear model regression is usually superior to this distribution in terms of the maximum likelihood statistic of the model. For this algorithm the dependent variable is the sum of payments conditional that payments have been made. Payment sums are usually censored at the amount of placement because this usually improves the fit of the model. This algorithm uses credit history information from the second input data set for each debtor and applies the extracted information to the credit events of the respective debtors included within the first data set. Alternatively, neural network techniques, discriminant analysis, random forests and other techniques may be used to generate an estimate for the sum of payments conditional that payments have been made.

For each receivable or credit event in the first dataset, the expected sum of payments is the product of the probability from the first algorithm with the above estimate for the conditional sum of payments:
Expected Monetary Amount (e.g., Dollars)=(Probability of Payment) x (Expected Conditional Payment Sum).

Software instructions defining a method for modeling debtor behavior according to the invention may be implemented by a computer or stored on a computer readable medium, wherein the method comprises obtaining historic customer placement data for each of at least one debtor in a debt portfolio; obtaining historic credit data for each of the at least one debtor in the debt portfolio; determining a probability of payment model by processing the historic customer placement data and historic credit data according to either of (1) a generalized linear modeling technique with a link function based upon a Generalized Beta of the Second Kind (GB2) family of distributions or (2) a generalized linear modeling technique using a link function based upon a member of the G-and-H family of distributions; and storing, in a memory, values corresponding to the probability of payment model.

One embodiment includes determining an expected conditional sum of payments model by processing the historic customer placement data and historic credit data according to either of (1) a generalized linear modeling technique using a member of the natural exponential family or (2) a maximum likelihood estimation fit to a member of the GB2; and storing, in the memory, values corresponding to the expected conditional sum of payments model.

Another embodiment includes determining an expected monetary amount using the probability of payment and the expected conditional sum.

Thus credit and/or placement data determines an expected dollar amount that is used to determine the relative credit worthiness of the debtors. The expected dollar amount is used to rank the debtor population within the debtor portfolio and provide thereby the second output score.

Alternatively, the Expected Monetary Amount is estimated directly by applying a combination of the first and second algorithms to the dependent variable sum of payments (rather than the conditional sum of payments). Such a procedure applies these algorithms in the context of a Tobit model with significant censorship at 0. That is, the Expected Monetary Amount may also be directly estimated using a Tobit model with or without the probability of payment model (as discussed herein) as an input to the Tobit model.

Thus, the evaluation engine is useful in providing a guide that enables creditors, collection agencies and debt buyers to determine a ranking of debtors according to which debtors are likely to pay and how much they are likely to pay. Using this guide, a collections agency may evaluate a debt portfolio. Similarly, a creditor company or collections company may prioritize its collections efforts with respect to a particular debtor population.

### Credit History Data

In various embodiments of the invention, credit bureau data is not used due to cost considerations or nonexistent/unreliable matching (i.e., no “hits”) of credit bureau data to customer placement data. In these embodiments, other data sources such as collections data generated by one or more companies or creditors is shared to provide at least some of the information otherwise gathered by commercial credit bureaus. For example, companies or creditors may share collections related data with each other within a particular industry, a particular geographic region, a particular distribution channel and the like. Thus, within the context of the present invention, credit history data may comprise credit bureau data, shared and/or individual corporate credit history data and other similar data.

### Bivariate Analysis Discussion for Development of Algorithms:

The invention uses a sample of historical placement data and/or credit data to be used as independent variables to develop a model that predicts the probability of payment and expected dollars to be paid. The model is then stored in memory for subsequent use in processing current placement data and credit data to predict current debtor behavior. The model may be debtor or account type specific to increase the correlation between the historic data driven model and the current data prediction.

Specifically, the invention creates a set of variables for bivariate analysis (“analysis variables”) for a debtor payment behavior model from a set of historical data elements that are old enough to observe the dependent variable. The data elements fall into two broad types: numerical and categorical. Some data elements may be considered a mixture of these types and hence are analyzed using a mixture of the methodologies described herein. If a categorical data element has any categories with a numerical value, an additional data element is constructed by treating each numerical category as a number and the other categories as missing values. The date of observation is always a data element.

The analysis variable creation process is performed, illustratively, four times, since conducting all of the desired transformations and mathematical operations in one processing step may be computationally burdensome; however, it may be desirable in some environments to do this in one step.

The data elements for the first iteration of the analysis variable creation process come from the data request(s) shown later in this patent application. The analysis variables created from the first iteration through the set of data elements become the data elements for the second iteration, etc. Analysis variables that would first arise from the last iteration (illustratively the fourth iteration) are “frontier variables”. If any candidate variables (described below) based upon frontier variables make the model cut described in step 240 then the entire process will be repeated for a fifth time and a new set of frontier variables will be defined. Additional repeats may be necessary until the process ceases to generate variables that make the model cut using a complexity criteria described below

Every data element becomes an analysis variable. Additional analysis variables are created from numerical or categorical data elements and may involve transformations such as logarithms and exponentiation as well as other mathematical transformations. Another type of transformation involves the breakdown of a data element into component analysis variables. For example, the date of write-off creates three component variables: year of write-off, month of write-off, and day of write-off. Yet another type of transformation involves categorization of a data element based upon additional information and/or databases. For example, the name of the creditor would be compared with a list of known sub prime issuers to create an analysis variable that indicates membership in this list.

Analysis variables may also be based upon relationships among data elements. Mathematical operations, such as addition, subtraction, multiplication, division, equalities, and inequalities are used to generate new analysis variables from each pair of numerical data elements. Equalities and inequalities can be applied to pairs of categorical data elements as well as mixed pairs.

Analysis variables are also created from groups of data elements. Mathematical functions such as sums, variances, averages and measures of volatilities as well as other statistical calculations are applied to groups of numerical data elements. For each group a family of count variables is constructed by counting the number of instances a particular value occurs in that group. Count variables can be constructed for groups of categorical data elements.

When available, a time series may be constructed and analysis variables created from its elements using variances, averages and measures of volatilities as well as other statistical calculations. The time series would also be considered as a group (described above).

After the set of analysis variables has been created, the invention creates variables for use as candidates in step 240 (“candidate variables”). All candidate variables must take only numerical values. Every numerical analysis variable generates one, possibly several, candidate variables. Missing values will be assigned a numeric value using the average of the variable for non missing values. Additional techniques for missing data include an inversion of the linear regression line for the dependent variable verses the analysis variable, where the inversion is calculated for the average of the dependent when the analysis variable is missing. An alternate technique comprises an imputation of value based upon statistical relationships of the analysis variable to other analysis variable(s), for example the assignment of a missing writeoff date as 180 days after a known last payment date.

Truncation and censorship are optionally used to treat outliers as missing values (described above) and/or replace extreme values with less extreme values. The invention uses percentile steps of, illustratively, 1%, 2%, 3%, 4%, 5%, etc. and 99%, 98%, 97%, 96% etc. to determine applicable cutoffs, though other steps may be used.

For a numerical analysis variable, one embodiment of the invention uses a method of maximum likelihood to create additional candidate variables from the creation of categories. The creation of categories is a step in the model building process for both of the algorithms described above.

For a continuous numerical analysis variable, the invention partitions variables into ordered categories of equal size. Within the context of the present invention, 100 ordered categories are usually sufficient, although a finer partition (i.e., more categories) is optionally used where data of sufficient volume is present. Missing values, if present, form a distinct category outside the 100 ordered categories and will be considered in the last step of the method.

For a discrete numerical analysis variable the process is similar, except that the “lumpiness” of the discrete variable may prevent the formation of 100 groups. For example, a discrete variable that has only three possible values would have only three possible categories.

For a categorical analysis variable with an a priori ordering the process is similar to that of a discrete numerical analysis variable. Furthermore, this variable is also analyzed as a variable without a priori ordering (as described further below).

For a categorical analysis variable that does not have an a priori ordering, such as a state of address, the invention orders the categories by the average value of the dependent variable in those categories.

For each N (N=1 to 100), the invention creates substantially all possible ordered groupings of the ordered categories. For example, if N=1, the group is the entire dataset. If N=2, the first possible grouping contains category 1 as group1 and category 2 thru 100 as group2. The second possible grouping contains category 1, 2 as group1 and category 3 thru 100 as group2. There are 99possible groupings because the invention enforces a rule that the categories of a group must be adjacent to each other in the ordering. For N=3 there are 98*99/2 possible groupings, etc.

For N=1, the invention evaluates the maximum likelihood of a model that assigns the dependent variable average to all observations (except observations with missing values). For N=2 the invention evaluates the maximum likelihood of all 99 possible groupings of a model that assigns the dependent variable average for a group to all observations in that group. The “best” grouping is found. By mathematical necessity the N=2 statistic will improve upon the N=1 statistic. The maximum likelihood is calculated in accordance with the model. For example, the bivariate analysis when the dependent variable is dichotomous will typically use logistic regression.

The invention then compares the maximum likelihood for N=1 to the maximum likelihood for the best N=2 group. The N=2 statistic is penalized using, illustratively, the Schwartz-Bayes Criteria to see if the improvement is statistically significant. Alternative statistical penalties include the Akaike Information Criterion. If it is, then the invention will discard N=1 and will use the N=2 groupings to create categories.

The process then generates candidate variables that cover the created groups by using 0/1 indicators. In general N groups will create N-1 candidate variables. For example, if N=3 groups have been determined, 2 candidate variables will be created. The first candidate variable has the value 1 for group 1 and 0 for groups 2 and 3. The second candidate variable has the value 1 for groups 1 and 2 and 0 for group 3. If a distinct missing values group is present then that group may be assigned 0 or 1, depending on which assignment creates the more predictive candidate variable as measured by the likelihood statistic of the corresponding 1 variable model. There would also be a candidate variable that will have the value 0 for all groups with non missing values and 1 for the distinct missing group.

Continuous candidate variables with a wide range may be truncated from below (left) or above (right) of the distribution in order to improve the likelihood statistics of the variable.

Thus a set of candidate variables that take only numerical values will have been created that will be used to build the models for probability or payment and/or conditional sum of payments. Some of these candidate variables will be designated frontier variables whose presence in a model developed in step 260 may necessitate more iterations of the analysis variable creation process and a possible repeat of the model development process. The goal is to create a sufficiently large set of variables so that subsequent iterations of the analysis variable creation process would not generate new predictive variables that would significantly improve the model.

It is noted that the term “payment” as used herein is intended to be generally synonymous with the term “monetary.”

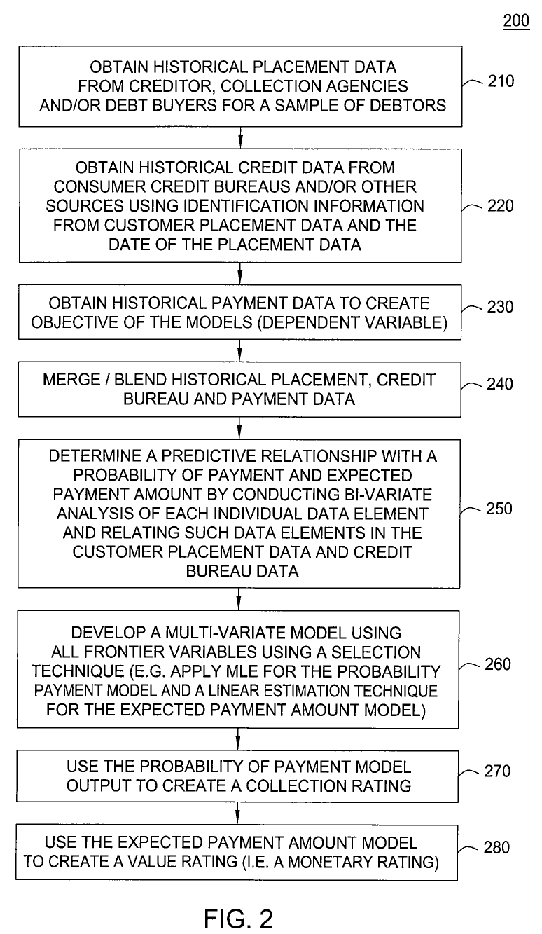

FIG. 2 depicts a flow diagram of methods for developing a blended recovery strategy for a debt portfolio. The methods 200 of FIG. 2 comprise a first set of steps (210-260) that provides an exemplary procedure for creating candidate variables for generating a model for use in accordance with the present invention. The methods 200 of FIG. 2 comprise a second set of steps (270-280) that provide an example of the use of the model in accordance with the invention.

Debt, debtors and debt portfolios may be of a particular type, such as consumer credit, mortgage, vehicle loan (e.g., automotive, motorcycle, boat and the like), student loan, hospital/medical and the like. Generally speaking, a model created according to the methodology described herein with respect to historical data of a particular type is particularly well suited for modeling future behavior of debtors associated with that type. Thus, a model created with respect to historical automobile loan placement data is likely to be more predictive of automobile loan debtor behavior than of medical debtor behavior. Moreover, the models created and discussed herein are improved over time by periodically aggregating additional historic information and refining the model accordingly.

The method 200 of FIG. 2 is entered at step 210 when historical placement data is obtained from a creditor, collection agency and/or debt buyer for a sample of debtors. The customer placement data comprises information associated with the debts or credit and collections events (CCEs) of a debtor population, and may comprise accounts receivable data associated with a particular debtor population. The debtor population may comprise those debtors associated with one or more than one creditors, where the debt has likely been delinquent or otherwise written off by the creditors as being uncollectible.

Accounts receivable data in connection with payment and non-payment of such debts is used to develop a recovery objective of the model (dependent variable). The objective of the probability model is typically at least a mere partial payment over a specified period of time after the snap shot date of the placement data. The objective of the expected payment amount model is the amount of payments received over a specified period of time after the snap shot date of the placement data. The inventors suggest a six month period of time is most desirable for assessing debtor payment behavior, however other time frames may also be desirable.

At step 220, historical credit bureau-type data is obtained from a consumer and/or commercial credit bureau (or other source) using identification information from the customer placement data received at step 210. That is, information identifying members of the debtor population associated with the received customer placement data is used to retrieve credit bureau data associated with the individual debtors within the debtor population and contemporaneous with the placement data date,

At step 230, historical payment data is obtained from the debt buyer, collection agency, creditor or other source that gathers payment information on such debts in connection with the collection activities of these entities. Examples of such payment data include a unique identifier for a related set of data elements (e.g., a name or identification number), a Last Payment Post Date, a Last Payment Amount, a Type of Payment and a date an account was scored. Other data may also be useful.

At step 240, the historical placement data, historical credit bureau-type data and the historical payment data is merged or blended together in an analytical data base by, illustratively, debtor account identifier and date of placement or date of desired score.

At step 250, a predictive relationship with a probability of payment and expected payment amount is determined by conducting a bivariate analysis of each individual data element and relating such data elements in the customer placement data and credit bureau-like data based upon the objective of the models and the analytical data base discussed above. That is, the placement data and credit bureau data associated with the debtor population is analyzed with respect to the debts incurred by the debtor population to determine for each debtor a likelihood of payment and the likelihood of payment amount. The bivariate statistical analysis between the data elements found in customer placement data and the data elements found in the credit bureau data is performed to conduct mathematical transformations to make important variables (e.g., likelihood of collection and amount of collection) more predictive of the model objective. Such transformations may entail logs, truncations, variances, averages, measures of volatilities, compound variables, missing variable assignments and the creation of dichotomous variables among other transformations and other statistical calculations.

Thus, a bivariate analysis of corresponding customer placement data and/or credit bureau data is used to create candidate variables that are used to estimate a probability of payment and an expected value of payment based upon a recovery model objective.

At step 260, a multivariate debtor payment behavior model is developed by processing all candidate variables in association with the dependent variables according to a selection technique. The set of candidate variables is expanded to include interactive effects between variables, for example, if A and B are candidate variables then A*B would also be processed. That is, the most predictive set of variables is found using a stepwise selection technique with a complexity penalty, such as the Schwartz Bayes Criterion. The significance level of the selection criteria is typically set at the 99% significance level, but the 95% level and other levels can be used with small samples. Alternatively a forward, backward or another selection technique can be used. For each variable, the sign of the coefficient is tested against the correlation of that variable with the dependent variable as an additional check for significance and also to discourage unnecessary co linearity in the model.

Also at step 260, a Maximum Likelihood Estimation (MLE) and General Linear Estimation Technique is employed to process the analytical database provided at step 240. Specifically, an MLE using the Logistic Regression form of the GB2 is used to create the Probability of Payment Model. It is noted that the inventors have found that Logistic Regression, as a member of the family of statistical distributions of Generalized Beta of the Second Kind (“GB2”), is relatively straightforward to compute, that the direction of the estimated parameters can be understood and that the technique is well suited for problems with dichotomous dependant variables, such as made payment versus no payment. However, the inventors also contemplate that other statistical distributions can be used to derive the MLE though these may be computationally burdensome without providing any significant increase in predictive power. Furthermore, while other techniques such as Neural Networks and Genetic Algorithms (among others) can be used, these may disadvantageously make the function computationally difficult to calculate and, therefore, it may be difficult to determine the direction of the estimated parameters. Generally, linear regression is not used due to the inherent unequal variance associated with the error structure of a dichotomous dependent variable. See the above discussion for Algorithm 1 for more details.

Also at step 260, a Generalized Linear Modeling Technique is employed using a normal distribution to estimate the Expected Payment Amount Model. Here the estimated probability of payment is an independent variable along with the Candidate Variables found to be predictive of the payment amount. It is noted that the inventors have found that Generalized Linear Modeling, as a member of the natural exponential family of statistical distributions, is relatively straightforward to compute, that the direction of the estimated parameters can be understood and that the technique is well suited for problems with positive continuous dependent variables, such as made payment versus no payment. However, the inventors also contemplate that other statistical distributions, such as members of the GB2 family, can be used to derive the MLE though these may be computationally burdensome without providing any significant increase in predictive power. Furthermore, while other techniques such as Neural Networks and Genetic Algorithms (among others) can be used, these may disadvantageously make the function computationally difficult to calculate and, therefore, it may be difficult to determine the direction of the estimated parameters. See the above discussion for Algorithm 2 for more details.

At step 270, the probability of payment model is used to provide a Collection Rating. The collection rating algorithm utilizes, for example, the output of the probability of payment model developed in step 260.

Probability of Payment is a function of Customer Placement Data and/or Bureau Data (or other credit history date) and is the output of the logistic model from the first algorithm described above with respect to step 260.

Collection Rating is a function of the Probability of Collections and is derived in one embodiment by producing percentiles of the probability distribution and by using the percentiles based on a ranking from highest probability of payment to lowest probability of payment to estimate a bell, such as provided in the following example (alternatively deciles or a Fibonacci sequence of the score interval endpoints among other methods may be used):
Best 5%—A1; 6-10%—A2; 11-15%—A3; 16-25%—B1; 26-35%—B2; 36-65%—B3; 66-75%—C1; 76-85%—C2; 86-90%—C3; 91-95%—D; and 96-100%—F.

Another embodiment uses the Jenks Optimization Method to determine, illustratively, 11 ratings (A1 thru F as above) with the average Collection Rating being B3. This method is used in a manner similar to the generation of choropleth maps. That is, a “spectrum” of debt may be represented by a plurality of different ranges where each account falls into only one of the ranges. These ranges partition the debt into different groups (e.g., 11 non-overlapping groups). Each range is associated with a respective rating, such as noted above with respect to the Collection Rating. These ratings are optionally fitted on a benchmark sample to establish invariant ratings as well as fitted specifically to the portfolio at hand.

At step 280, the expected payment amount model is used to create a value or monetary (e.g., dollar) rating. Expected Payment Amount is a function of Customer Placement Data and/or Bureau Data (or other credit history data) and is the output of the generalized linear estimation from the second algorithm described above with respect to step 260.

Monetary (or Dollar) Rating is a function of Expected Payment Amount and is derived in one embodiment by producing percentiles of the expected payment distribution and by using the percentiles based on a ranking from highest expected amount of payment to lowest expected amount of payment to estimate a bell curve, as provided in the following example (alternatively deciles or a Fibonacci sequence of the score interval endpoints among other methods may be used):
Best 5%—A1; 6-10%—A2; 11-15%—A3; 16-25%—B1; 26-35%—B2; 36-65%—B3; 66-75%—C1; 76-85%—C2; 86-90%—C3; 91-95%—D; 96-100%—F.

Another embodiment uses the Jenks Optimization Method to determine, illustratively, 11 ratings (A1 thru F as above) with the average Monetary Rating or Dollar Rating being B3, as discussed above with respect to step 270.

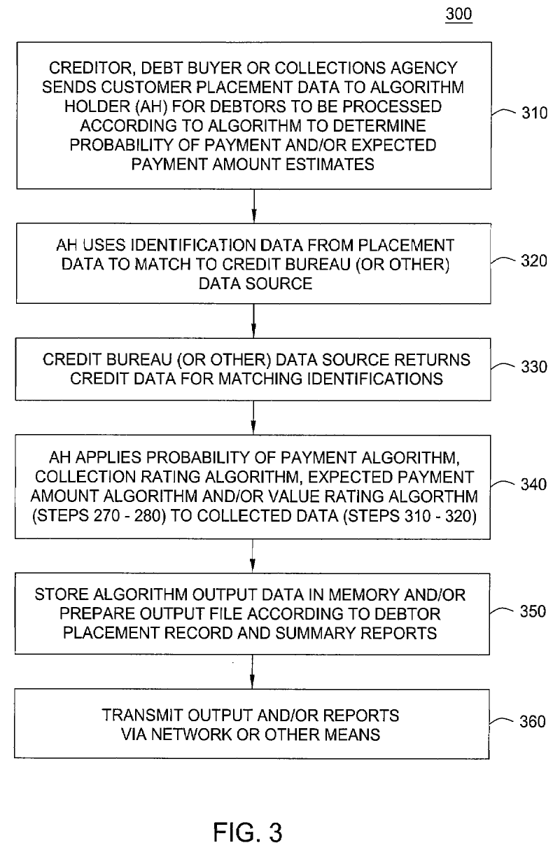

FIG. 3 depicts a flow diagram of a method for implementing a blended recovery strategy. Specifically, the method 300 is entered at step 310 when a creditor, debt buyer or collection agency sends customer placement data to an algorithm holder (AH) for debtors to be processed according to one or more algorithms to determine probability of payment, expected payment amount estimates and the like. The algorithm holder comprises an entity in possession of, for example, the models discussed above with respect to FIG. 2, such as the collection rating and/or value rating algorithms.

At step 320, the algorithm holder provides matching data (based on identification information in the placement data) to a credit bureau (or other) source. The matching data (or, alternatively all data or a subset of the remaining data) sent to the credit bureau defines the type of data associated with each debtor that is appropriate to the collection rating and/or dollar rating algorithm.

At step 330, the credit bureau (or other) data source returns credit data associated with those debtors matching the identification criteria provided at step 310.

At step 340, the coefficients and functional form of the Maximum Likelihood Estimate assuming a logistic function from step 270 is applied to process two data sets; namely, the customer placement data received at step 310 and the credit bureau data received at step 330. Also at step 330, the coefficients and functional form of the Linear Estimation Technique from step 280 is applied to process two data sets; namely, the customer placement data received at step 310 and the credit bureau data received at step 3330. Finally, the Collection Rating algorithm and the Value/Dollar Rating Algorithms are applied.

At step 350, the algorithm output data is stored in memory and/or used to prepare an output file according to debtor placement record and summary reports. The output file contains, for example, an Account Identifier, a Probability of Payment, a Collection Rating, an Expected Payment Amount and Value/Dollar Rating on each record as well as associated summary reports that provide a frequency distribution of the ratings and the associated predictions of the probability of payment and the expected amount of payment.

At step 360, the output file and/or associated reports are transmitted to the customer via a network such as the Internet or by some other electronic or non-electronic transfer means. An exemplary output report is provided below in simplified form with respect to Table 1:

TABLE 1

| Item | Name |
|---|---|
| 1 | Identifier |
| 2 | Dollar Rating |
| 3 | Expected Payment |
| | Amount |
| 4 | Collection Rating |
| 5 | Probability of Payment |

### Customer Placement Data

Customer placement data is illustratively submitted in the form and format described herein with respect to the “Data Request” attachments. However, the form and format of the data are merely exemplary. Other form and formats of such data may be utilized within the context of the present invention. An exemplary listing of customer placement data is provided below in simplified form with respect to Table 2 (more or fewer data elements may be used):

TABLE 2

| NAME | DESCRIPTION | NAME | DESCRIPTION |
|---|---|---|---|
| IDENTIFIER | Unique Identifier | PLACEMENT | Placement Status of |
| | | STATUS | Account (Late Stage, |
| | | | Early Out, Precollect, |
| | | | Fresh, First, Second, |
| | | | Third, Warehouse, |
| | | | Other, Mix, Quad) or |
| | | | (Legal) or (Judgment) |
| CREDITOR | Original Credit | DEBT_TYPE | Debt Type |
| ACCT | Grantor Account ID | | (Automobile, Credit |
| | (e.g. Credit card | | Card, Deficiency |
| | number) | | Balance, Fee, Health |
| | | | Club, Home Equity, |
| | | | Installment Loan, |
| | | | Medical, Mortgage, |
| | | | Overdraft, Private |
| | | | Label, Student Loan, |
| | | | Telecom, Tax, Utility, |
| | | | Other) |
| WRITEOFF | Write Off Date or | PORTFOLIO_TYPE | Portfolio Type |
| DATE | Judgment Date | | (SuperPrime, Prime, |
| | | | SubPrime, Secured, |
| | | | A Credit, A Minus, B |
| | | | Credit, C Credit, |
| | | | Other) is the credit |
| | | | quality of the account |
| | | | at time of origination |
| WRITEOFF | Write Off Amount | CREDLIM | Credit Limit |
| AMOUNT | | | |
| LASTPMTDT | Date of last | CREDITOR | Original Credit |
| | payment at time of | | Grantor Name |
| | purchase or | | |
| | placement | | |
| LASTPMTAMT | Amount of last | REPORT_NAME | Name for |
| | payment at time of | | summarizing reports |
| | purchased or | | (PMI can generate |
| | placement | | reports by name(s) |
| | | | provided) |
| ACCTOPEN | Date account was | ENTITY_TYPE | Debtors Legal |
| DATE | opened with original | | structure |
| | creditor | | |
| PLACEMENT | Date account was | SPEC_CODE | Three letter code(s) |
| DATE | purchased or | | that identifies |
| | placed for collection | | potentially |
| | | | unscoreable |
| | | | situation. Multiple |
| | | | codes allowed (DEC— |
| | | | Deceased, BKR— |
| | | | Bankrupt, BKD— |
| | | | Bankruptcy |
| | | | Dismissed, BKF— |
| | | | Bankruptcy Filed, |
| | | | OOB—Out-of-Bus) |
| PLACEMENT | Purchase Amount | SCORE_TYPE | Character code that |
| AMOUNT | or Placement | | Identifies Score |
| | Amount | | Type - (DBS, URS) |
| DEBTOR | Debtor's Name, | SNAPSHOT | Date at which file to |
| INFORMATION | Address, etc. | DATE | be scored was last |
| | | | updated |
| OTHER | Other Debtor's | COLLECTOR | Notes from collector, |
| DEBTOR | Information | NOTES | collection action or |
| INFORMATION | | | collection codes |
| | | | (client/creditor |
| | | | provides code |
| | | | definitions) |
| INVLASTPMTDT | Last payment date | INVSUMPAY | Sum of payments |
| | to creditor, post | | made to creditor post |
| | purchase/ | | purchase/placement |
| | placement date | | date |
| INVLASTPMTAMT | Last payment | INVCURAMT | Current balance |
| | amount to creditor, | | owed to creditor now |
| | post | | |
| | purchase/placement | | |
| | date | | |

### Credit and Other Information

Commercial or consumer credit related information associated with a period of time (e.g., at time of placement data, or 3 months, 6 months, one year and the like) in association with a placement or scoring period, with a demographic profile (e.g., education level, age, gender, income level and the like) or with other information related to individual debtors may be used within the context of the present invention.

### Placement Data

In addition to the above exemplary listing, placement data optionally includes some or all of the typical Commercial Bureau Data Elements, Consumer Bureau Data Elements, and, optionally, demographic data, labor statistics, social security administration information and the like.

### The following are examples of Commercial Bureau Data Elements:

Year that company started in business
SIC (Standard Industrial Code)
Number of employees
Type of business structure: corporation, partnership, proprietorship, etc.
Number of commercial trade experiences
Number of days beyond terms weighted by dollars or in an index
Number of slow trade experiences
Pubic record data on liens, judgments and bankruptcy
Information on any trades placed for collection
Number of bank trades
Number of commercial inquiries to the bureau
Number of UCC filings
Highest credit amount extended
Amount of credit outstanding

### The following are examples of Consumer Bureau Data Elements:

Number of trades open ever
Number of trades open ever that went past due or to write-off/collections
Number of trades open in last year
Number of trades open in last two years
Number of trades open in last year that went past due or to write-off/collections
Number of trades open in last two years that went past due or to write-off/collections
Excluding Mortgage trades, ratio of total current balance outstanding to credit limit or to trade's original loan amount
Ratio of total current balance outstanding for revolving trades to total revolving trade credit limit
Number of active revolving trades with ratio of current balance outstanding greater than 50% of revolving trades credit limit
Number of revolving trades
Number of open mortgages
Total current balance outstanding on mortgage trades
Number of mortgage trades that went past due in last year
Number of mortgage trades that went past due in last two years
Date of first trade on record or age of oldest trade in months
Number of derogatory public records (e.g. past and current bankruptcies, foreclosures among other items)
Months since last derogatory public record
Indicator if there is open bankruptcy

Thus, in one embodiment of the invention, a model is constructed using placement data (e.g., Customer Placement Data), credit information data (e.g., Credit Bureau Data), and demographic data bases (e.g., census statistics and/or Bureau of Labor and Statistics). Demographic data is optionally attached to placement data records using keys such as zip codes or state identifier. Performance data may be summarized over a performance window.

The invention transforms the placement and/or credit history and/or matched demographic data into variables that take numeric values or specified categories. These transformed variables are the independent variables in a logistic regression, or a generalized linear model, or a maximum likelihood estimate of a statistical function such as a member of the GB2 family, as per the above discussion.

The dependent variables are the incidence of a payment and the sum of payments in a specified time frame. Standard time frames are 6 months and 18 months and can be adapted as needed to other time frames. Incidence of payment is defined as the payment of at least $1 over a specified time frame, but other amounts can be used. The sum of payments can be customized to certain types of payments per client specification.

The algorithm for incidence of payment is typically logistic regression. See Algorithm 1 above.

The algorithm for sum of payments is in 2 parts, as follows:

A generalized linear model is typically used to estimate the sum of payments conditional that there is an incidence of payment. This model uses placement and/or credit information and/or demographic data, such as discussed above with respect to Algorithm 2.

Expected Payment Amount is a function of Predicted Incidence of Payment and Predicted Conditional Sum (e.g., Predicted Incidence of Payment multiplied by Predicted Conditional Sum). The Predicted Conditional Sum is the sum of payments over the time frame (example 6 months), conditional that the sum of payments meets the threshold (example $1).

Given a portfolio of accounts, the invention applies the model to estimate the incidence of payment and expected sum of payments for each account.

Output reporting comprises, illustratively, a multiple element score vector for each account and a Summary workbook for the entire group of accounts.

FIG. 4 depicts a high-level block diagram of a general-purpose computer suitable for use in performing any of the functions described herein. As depicted in FIG. 4, system 400 comprises a processor element 402 (e.g., a CPU), a memory 404, e.g., random access memory (RAM) and/or read only memory (ROM), a performance monitoring module 405, and various input/output devices 406 (e.g., storage devices, including but not limited to, a tape drive, a floppy drive, an optical disk drive, hard disk drive or a compact disk drive, a receiver, a transmitter, a speaker, a display, an output port, and a user input device such as a keyboard, a keypad, a mouse, and the like).

It should be noted that the present invention may be implemented in software and/or in a combination of software and hardware, e.g., using application specific integrated circuits (ASIC), a general purpose computer or any other hardware equivalents. In one embodiment, the present performance monitoring process 405 can be loaded into memory 404 and executed by processor 402 to implement the functions as discussed above. As such, performance monitoring process 405 (including associated data structures) of the present invention can be stored on a computer readable medium or carrier, e.g., RAM memory, magnetic or optical drive or diskette and the like.

It is contemplated that some of the steps discussed herein as software methods may be implemented within hardware, for example, as circuitry that cooperates with the processor to perform various method steps. Portions of the present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast or other signal bearing medium, and/or stored within a working memory or mass storage associated with a computing device operating according to the instructions.

FIG. 5 depicts a sample incidence predictions report that tabulates predicted performance based upon ranking by the probability of payment. FIG. 6 depicts a sample dollar predictions report that tabulates predicted performance based upon ranking by the expected dollars to be liquidated. Each of these reports may be generated by, for example, the report generator 126 discussed above with respect to FIG. 1 or similar functional elements. The reports of FIG. 5 and FIG. 6 include 10 columns labeled (A) through (J).

The column labels for FIG. 5 correspond to the following: (A) =Result of calculated score; (B)=Number of accounts in portfolio with a rating in (A); (C) is based upon (B); (D)=Placement/Collection balance of accounts in portfolio with rating in (A); (E)=% of accounts with a qualifying payment, which is based upon Collection Rating prediction of performance for this portfolio; (F) is based upon (D) and Dollar Rating prediction of the sum of payments during the performance period per account; (G)=(D)×(F)/(B); (H)=(E)×(B), which is the predicted numbers of accounts with at least one payment during the performance period; (I) is based upon (B); and (J) is based upon (H).

The column labels for FIG. 6 correspond to the following: (A)=Result of calculated score; (B)=Number of accounts in portfolio with a rating in (A); (C) is based upon (B); (D)=Placement/Collection balance of accounts in portfolio with rating in (A); (E)=% of accounts with a qualifying payment, which is based upon Collection Rating prediction of performance for this portfolio; (F)=(H)/(D); (G) is the monetary value or Dollar Rating prediction of the sum of payments during the performance period per account; (H) is the monetary value or Dollar Rating prediction of the sum of payments during the performance period for accounts by Dollar Rating; (I) is based upon (B); and (J) is based upon (B).

Within the context of the present invention, a Collection Score is defined as the probability of payment (of the debtor or group of debtors) multiplied by 100. Similarly, the Monetary or Dollar Score is the expected payment amount in, illustratively, dollars for the debtor or group of debtors. The sum of the individual account Dollar Scores in a portfolio equals the value of a debt portfolio. The sum of the individual account Collection Scores in a portfolio (divided by 100) is equal to the expected number of accounts that will have a payment.

In one embodiment an analysis using one or both of the probability of payment and expected payment amount is used to prioritize accounts in a debt portfolio to improve a recovery strategy.

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A computer readable medium containing a program which, when executed by a processor, performs a method for modeling debtor behavior, comprising:
obtaining historic customer placement data for each of at least one debtor in a debt portfolio;
obtaining historic credit data for each of the at least one debtor in the debt portfolio;
determining a probability of payment model by processing the historic customer placement data and historic credit data according to either of (1) a generalized linear modeling technique with a link function based upon a Generalized Beta of the Second Kind (GB2) family of distributions or (2) a generalized linear modeling technique using a link function based upon a member of the G-and-H family of distributions; and
storing, in a memory, values corresponding to the probability of payment model.

2. The method of claim 1, further comprising:
determining an expected conditional sum of payments model by processing the historic customer placement data and historic credit data according to either of (1) a generalized linear modeling technique using a member of the natural exponential family or (2) a maximum likelihood estimation fit to a member of the GB2;
storing, in a memory, values corresponding to the expected conditional sum of payments model.

3. The method of claim 2, further comprising:
determining an expected monetary amount using the probability of payment and the expected conditional sum.

4. The method of claim 1, further comprising:
determining an expected monetary amount either directly using the Tobit model or using the Tobit model with the probability of payment model as an input to the Tobit model.

5. The method of claim 1, wherein the probability of payment model is determined using one or both of logistic regression and probit regression.

6. The method of claim 1, wherein the modeling techniques comprise one or more of a neural network processing technique, a linear regression technique, a discriminant analysis technique and a random forests technique.

7. The method of claim 1, wherein the generalized linear modeling uses one or more of Normal, Poisson, Gamma, Inverse Gaussian, Negative Binomial, Logarithmic and Compound Poisson/Gamma distributions.

8. The method of claim 5, wherein the generalized linear modeling technique is further adapted according to a complexity penalty criterion.

9. The method of claim 8, wherein the complexity penalty criterion comprises a Schwartz Bayes Criterion.

10. The method of claim 1, wherein the historic credit data comprise credit bureau data.

11. The method of claim 1, wherein the debt portfolio is associated with a type of debt.

12. The method of claim 11, wherein the type of debt comprises one or more of vehicle loan debt, education loan debt, medical debt, credit card debt, trade credit, health club debt, mortgage debt and tax debt.

13. The method of claim 1, further comprising:
using the probability of payment model to process current customer placement data and current credit data associated with a second debt portfolio to determine thereby a probability of payment for each of at least one account in the second debt portfolio.

14. The method of claim 13, wherein:
each account of the second debt portfolio is associated with a collection score calculated as its respective probability of payment multiplied by 100; and
a Collection Score for the second debt portfolio is calculated as the sum of all the collection scores.

15. The method of claim 13, further comprising:
establishing a collection rating as a function of the probability of payment for the accounts in the second debt portfolio.

16. The method of claim 15, wherein the probability ratings of the accounts in the second debt portfolio are divided into a plurality of ranges.

17. The method of claim 16, wherein the ranges are determined using a bell curve, division into deciles, Fibonacci sequences of the score interval endpoints or a Jenks optimization method.

18. The method of claim 3, further comprising:
using the expected monetary amount model to process current customer placement data and current credit data associated with a second debt portfolio to determine thereby an expected conditional sum of payments for each of at least one account in the second debt portfolio.

19. The method of claim 18, wherein:
each account of the second debt portfolio is associated with a Monetary Score calculated as its respective expected payment amount; and
a Monetary Score for the second debt portfolio is calculated as the sum of all the Monetary Score.

20. The method of claim 18, further comprising:
establishing a monetary rating as a function of the expected payment amounts for the accounts in the second debt portfolio.

21. The method of claim 20, wherein the monetary ratings of the accounts in the second debt portfolio are divided into a plurality of ranges.

22. The method of claim 21, wherein the ranges are determined using a bell curve, division into deciles, Fibonacci sequences of the score interval endpoints or a Jenks optimization method.

23. The method of claim 2, further comprising:
using the probability of payment model to process current customer placement data and current credit data associated with a second debt portfolio to determine thereby a probability of payment for each of at least one account in the second debt portfolio; and
using the expected conditional sum of payments model to process current customer placement data and current credit data associated with a second debt portfolio to determine thereby an expected conditional sum of payments for each of at least one account in the second debt portfolio.

24. The method of claim 23, further comprising:
ranking by an expected monetary amount determined using the probability of payment and the expected conditional sum associated with the second debt portfolio to determine a prioritization of collection activity.

25. A computer readable medium containing a program which, when executed by a processor, performs a method for using at least one of the debtor behavior models of claim 2, comprising:
receiving customer placement data associated with a second debt portfolio;
obtaining credit data for at least a portion of the debtors within the second debt portfolio;
processing the received customer placement data and obtained credit data according to a debtor behavior model; and
storing, in a memory, values corresponding to an expected monetary amount for the portion of the debtors within the second debt portfolio.

26. The method of claim 25, further comprising:
determining a total value of the second debt portfolio.

27. The method of claim 25, further comprising:
prioritizing the accounts in the second debt portfolio using one or both of probability of payment and expected payment amount to improve a recovery strategy.

28. The method of claim 25, further comprising:
grouping the accounts in the second debt portfolio using one or both of probability of payment and expected payment amount to improve a recovery strategy.

29. The method of claim 1, wherein:
the processing the historic customer placement data and historic credit data includes a bivariate analysis utilizing a plurality of analysis variables including the data elements within the historical customer placement and credit data and additional analysis variables created using numerical or categorical data elements.

30. The method of claim 29, wherein:
the bivariate analysis further utilizes demographic data.

31. The method of claim 1, wherein the placement data comprises an amount and age for each receivable.

32. A computer readable medium containing a program which, when executed by a processor, performs a method for determining a debtor behavior model, comprising:
obtaining one or both of historic customer placement data for each of at least one debtor in a debt portfolio and historic credit data for each of the at least one debtor in the debt portfolio;
processing the one or both of historic customer placement data and historic credit data according to a generalized linear modeling technique with a Generalized Beta of the Second Kind distribution to determine thereby a model describing a maximum likelihood estimation of at least one of a probability of payment and an estimated payment amount for each account in the debtor population; and
storing, in a memory, values corresponding to properties of the determined model.

33. A computer readable medium containing a program which, when executed by a processor, performs a method for modeling debtor behavior, comprising:
obtaining historic customer placement data for each of at least one debtor in a debt portfolio;
determining a probability of payment model by processing the historic customer placement data according to either of (1) a generalized linear modeling technique with a link function based upon a Generalized Beta of the Second Kind (GB2) family of distributions or (2) a generalized linear modeling technique using a link function based upon a member of the G-and-H family of distributions; and
storing, in a memory, values corresponding to the probability of payment model.

34. The method of claim 33, further comprising:
determining an expected conditional sum of payments model by processing the historic customer placement data according to either of (1) a generalized linear modeling technique using a member of the natural exponential family or (2) a maximum likelihood estimation fit to a member of the GB2;
storing, in a memory, values corresponding to the expected conditional sum of payments model.

35. The method of claim 34, further comprising:
determining an expected monetary amount using the probability of payment and the expected conditional sum.

36. A computer readable medium containing a program which, when executed by a processor, performs a method for modeling debtor behavior, comprising:
obtaining historic credit data for each of at least one debtor in a debt portfolio;
determining a probability of payment model by processing the historic credit data according to either of (1) a generalized linear modeling technique with a link function based upon a Generalized Beta of the Second Kind (GB2) family of distributions or (2) a generalized linear modeling technique using a link function based upon a member of the G-and-H family of distributions; and
storing, in a memory, values corresponding to the probability of payment model.

37. The method of claim 36, further comprising:
determining an expected conditional sum of payments model by processing the historic credit data according to either of (1) a generalized linear modeling technique using a member of the natural exponential family or (2) a maximum likelihood estimation fit to a member of the GB2;
storing, in a memory, values corresponding to the expected conditional sum of payments model.

38. The method of claim 37, further comprising:
determining an expected monetary amount using the probability of payment and the expected conditional sum.
